(19) United States
(12) Patent Application Publication
(10) Pub. No.: US 2013/0146534 A1
(43) Pub. Date: Jun. 13, 2013

(54) METHOD AND SYSTEM FOR RELEASING NITROGEN FROM FILTER MEDIA

(71) Applicants: Ivan X. Zhu, Cranberry Township, PA (US); Eugene M. Vegso, Cranberry Township, PA (US)

(72) Inventors: Ivan X. Zhu, Cranberry Township, PA (US); Eugene M. Vegso, Cranberry Township, PA (US)

(73) Assignee: XYLEM WATER SOLUTIONS ZELIENOPLE LLC, Zelienople, PA (US)

(21) Appl. No.: 13/581,815

(22) PCT Filed: Mar. 1, 2011
(86) PCT No.: PCT/US2011/026634

§ 371 Date: Nov. 8, 2012

Related U.S. Application Data
(60) Provisional application No. 61/309,891, filed on Mar. 3, 2010.

(51) Int. Cl. C02F 3/00

(52) U.S. Cl. CPC C02F 3/006
USPC 210/614

(57) ABSTRACT

A method and system for removing nitrogen from a downflow denitrification media filter which optimizes the bump timing increasing productivity. The method comprises measuring the influent and effluent nitrate concentrations and determining total nitrate-nitrogen accumulation. A bump of the filter is initiated based on a comparison of the total nitrate-nitrogen accumulation with a predetermined accumulated nitrate-nitrogen value. The method may utilize a processor, having a memory, which is capable of communicating with, receiving input from and sending output to, and controlling the filter and any in-line measurement tools. The method may include a bump timing factor to adjust the bump interval when the actual operating conditions are substantially different from the operating conditions that were present when the predetermined accumulated nitrate-nitrogen value was determined. A method for predicting the bump interval and determination of an estimated time until the next bump are also included.

### CROSS REFERENCE TO RELATED APPLICATIONS

This application claims priority to U.S. Provisional Patent Application No. 61/309,891, filed Mar. 3, 2010, the entire disclosure of which is hereby incorporated by reference.

### BACKGROUND OF THE INVENTION

1. Field of the Invention

The present invention is generally directed to a method for releasing nitrogen from a downflow denitrification media or packed-bed filter and, more specifically, a method of determining when to initiate a “bump” of the filter, also known as a nitrogen release cycle, based on actual operating conditions.

2. Description of Related Art

Downflow denitrification media or packed-bed filters are used to remove nitrates from wastewater. The filter has a gravity downflow packed bed of media through which the wastewater is fed. Microorganisms, such as anoxic heterotrophic bacteria, are attached to the filter media. As the nitrate containing water passes through the media in the filter, the microorganisms break down the nitrates, use a carbon source such as methanol, and release nitrogen gas. As the nitrogen gas bubbles build in the media bed, they increase the head loss through the filter resulting in lower flow through the media unless more driving head is used to maintain a constant flow rate.

The nitrogen is purged from the filter media by the technique of “bumping” the filter which is often referred to as performing a nitrogen release cycle. Bumping is essentially a short backwash of water through the media that flushes out the nitrogen bubbles. It is not a full backwash as would be necessary to purge trapped suspended matter or some microorganisms from the bed but involves an upward flow of water with sufficient velocity to loosen, coalesce and purge the trapped nitrogen gas from the bed. A proper bumping regime will help to maximize filter runtimes between full backwashes and optimize energy usage. This bumping procedure requires taking the filter offline resulting in a loss of production for the time that the filter is being bumped.

Bumping of the filter is generally initiated based on a time-based cycle, whereby the filter is bumped at set, constant time intervals. Typically, a filter is bumped at periods between 30 minutes to 8 hours. Alternatively, the filter may be bumped when the head loss increases by a maximum tolerable level. Neither method accurately takes into account variability in loading and operating conditions, such as temperature, water quality, rainfall events, and operational changes. This can result in shorter filter runtimes and lost productivity when the bumping is performed earlier or later than is actually necessary. There is therefore a need for a method of initiating bumping of the filter that takes into account variability in the operating conditions.

### SUMMARY OF THE INVENTION

The present invention is a method for bumping the filter based on actual operating conditions. It causes the filter to be bumped when the nitrogen level reaches an unacceptable level regardless of how much time has elapsed since the last bump. This better assures that, under operating conditions resulting in high loading, the filter is bumped before productivity is significantly decreased and that, under conditions of low loading, the filter is not bumped until it is necessary. Thus, increased productivity is realized in both cases.

The method and system of the present invention apply to downflow denitrification media filters having a media bed, an influent flow into the filter, and an effluent flow from the filter. The method comprises measuring the influent and effluent nitrate concentrations and determining total nitrate-nitrogen accumulation based on at least the measured influent and effluent nitrate concentration. A bump of the filter is initiated based on a comparison of the total nitrate-nitrogen accumulation with a predetermined accumulated nitrate-nitrogen value. The total nitrate-nitrogen accumulation may be determined using periodic measurements of the influent and effluent nitrate concentrations, the time interval between measurements, the flow rate of water through the filter and the area of the filter. The comparison of the total nitrate-nitrogen accumulation with the predetermined nitrate-nitrogen accumulation value may be accomplished by a number of suitable methods.

Alternatively, the method may utilize a processor, having a memory, which is capable of communicating with, receiving input from and sending output to, and controlling the filter and any in-line measurement tools.

In addition, either method may be modified to include a bump timing factor. The bump timing factor may be used to adjust the bump interval when the actual operating conditions are substantially different from the operating conditions that were present when the predetermined accumulated nitrate-nitrogen value was determined.

Further, the present invention includes a method for predicting the bump interval comprising determining total nitrate-nitrogen accumulation speed as a function of time and predicting the bump interval based on the total nitrate-nitrogen accumulation speed as a function of time and a predetermined accumulated nitrate-nitrogen value. The method may also include determination of an estimated time until the next bump. These methods may also be accomplished using a processor and modified using a bump timing factor.

The present invention also includes a system for the operation of a downflow denitrification filter having a media bed, an influent flow into the filter, and an effluent flow out of the filter comprising a processor having a memory, an in-line nitrate probe located before the media bed for measurement of the nitrate concentration of the influent, an in-line nitrate probe located after the media bed for measurement of the nitrate concentration of the effluent, an in-line flow meter for measurement of the flow rate of the water through the media bed, and a backwash system for removing nitrogen from the media bed. The processor is capable of communicating with the in-line nitrate probes, the flow meter, and the backwash system and initiating a bump to remove nitrogen from the media bed based on the information provided by the in-line nitrate probes and the flow meter.

### BRIEF DESCRIPTION OF THE DRAWINGS

FIG. 1 is an overview of a typical downflow denitrification media filter.

### DESCRIPTION OF THE PREFERRED EMBODIMENTS

Downflow denitrification media or packed-bed filters remove nitrates from water using a biological process whereby microorganisms, such as anoxic heterotrophic bacteria, attach to the filter media. As the nitrate-containing water passes through the media in the filter, the microorganisms break down the nitrates, use a carbon source such as methanol, and release nitrogen gas. As the nitrogen gas bubbles build in the media bed, they increase the head loss in the filter resulting in a lower flow through the media therefore requiring more driving head to produce a constant flow rate.

The nitrogen is purged from the filter media by the technique of “bumping” the filter which is often referred to as performing a nitrogen release cycle. Bumping is essentially a short backwash of clean water through the media that flushes out the nitrogen bubbles. It is not a full backwash as would be necessary to purge trapped suspended matter or active microorganisms from the bed but involves an upward flow of water with sufficient velocity to loosen, coalesce and purge the trapped nitrogen gas from the bed. This bumping procedure requires taking the filter offline resulting in a loss of production for the time that the filter is being bumped.

It is desired to bump the filter only as often as is necessary to avoid unacceptably deteriorated performance of the filter, i.e., high head loss and low flow rate, but not to bump the filter too often resulting in loss of productivity from the filter being off-line during the bumping procedure. Providing effective timing for the bumping procedure so as to keep the bed from experiencing high head loss without excessive delays and interruptions from the bumping can be a challenge. A traditional method employs a set timing interval for bumping the filters. While a set timing interval may be effective for a given hydraulic and nitrate-nitrogen loading, it may be excessive for lower loadings and insufficient when the loadings are higher.

It is possible to determine empirically a predetermined accumulated nitrate-nitrogen value that assures that the nitrogen gas accumulation levels do not affect optimal performance of the filter. Here nitrate-nitrogen (NOₓ—N) refers to both NO₃—N and NO₂—N and the removed nitrate-nitrogen in pounds is approximately equal to the nitrogen gas in pounds that has accumulated in the filter bed. However, this predetermined accumulated nitrate-nitrogen value, while a good estimation for many situations will only be completely accurate for the operating conditions that existed at the time at which the empirical value was determined. One such empirical value was determined by Savage et al. (Development Report for Nutrient Removal Project at Indian Lake Treatment Plant, North Huntington, Pa., Dravo Corp, 1972) to be 0.05 lbs/sq. ft. of filter per bump. Others reported that different media and underdrain arrangement resulted in a decreased frequency of nitrogen release cycles indicating larger gas accumulation in the filter bed (WEF, Wastewater treatment plant design, Manual of Practice No. 8, 1992).

Based on the empirically predetermined accumulated nitrate-nitrogen value, the average nitrate concentration of the influent, the average nitrate concentration of the effluent, the average flow rate of the water through the filter, and the size of the filter, it is possible to determine an estimated time interval between bumping. This is determined according to the following formula:

$$Bumping interval = \frac{M}{( {N}_{i} - {N}_{e} ) \times F / A}$$

where:

M=predetermined accumulated nitrate-nitrogen per unit area of filter

Nᵢ=average nitrate concentration of influent

Nₑ=average nitrate concentration of the effluent

F=flow rate of the water through the filter

A=area of the filter

For example, for a predetermined accumulated nitrate-nitrogen of 0.05 lbs/sq. ft., an average influent nitrate concentration of 19 mg/l, an average effluent nitrate concentration of 1 mg/1, 1000 sq. ft. of filter area, and a flow rate of 3000 gpm, the bumping interval would be 111 minutes.

$$Bumping Interval = \frac{0.05 lb \text{/} sq . ft . - bump}{( 19 mg \text{/} l - 1 mg \text{/} l ) \times 3000 gpm \div 1000 sq . ft .} \times 1000 mg \text{/} g \times 453 g \text{/} lb . \div 3.785 l \text{/} gal = 111 min .$$

Depending on the units for which each of the values in the formula is obtained, it may be necessary to convert the values to compatible units using known conversion factors as shown in the example above.

However, operating conditions are not constant over time. Diurnal swings where the flow rate and nitrate loading change are normal. Also, seasonal changes in temperature and water quality, rainfall events, and operational changes may occur.

The present invention addresses such changes and allows for optimization of the bumping interval by responding to actual conditions on a continuous basis rather than relying on an average bumping interval which may be too short or too long depending on the operating conditions.

In the present invention, the timing of the bump is initiated based on a comparison of the calculated total nitrate-nitrogen accumulation with a predetermined accumulated nitrate-nitrogen value. By comparing actual operating values to the predetermined accumulated nitrate-nitrogen value that optimizes filter performance, the bump timing can also be optimized.

The total nitrate-nitrogen accumulation can be determined using any suitable method. One such method is described here. The influent, Nᵢ, and effluent, Nₑ, nitrate concentrations are determined periodically at regular time intervals, I. The influent nitrate concentration may be determined by off-line measurement or by the use of an in-line nitrate probe 1 located before the water enters the media bed 2. The effluent nitrate concentration may be determined by off-line measurement or by the use of a second in-line nitrate probe 3 located after the water leaves the media bed 2. Alternatively, the effluent nitrate concentration set point may be used. At the same time, the flow rate is determined using in-line flow meter 4. Alternatively, the flow rate set point may be used. The nitrate-nitrogen accumulation for the segment of the process that occurs between periodic measurements, Nₙ, is determined according to the following formula:

Nₙ=(Nᵢ−Nₑ)×F/A×I
where:
Nₙ=nitrate-nitrogen accumulation for segment n, where n=the number of the segments after the bump
Nᵢ=measured nitrate concentration of the influent
Nₑ=measured nitrate concentration of the effluent or effluent nitrate concentration set point
F=measured flow rate or flow rate set point
A=area of the filter
I=time interval between measurements

After each measurement, the nitrate-nitrogen accumulation for that segment, Nₙ, is added to the total nitrate-nitrogen accumulation, N_{T}=ΣN₁, N₂, N₃ . . . , such that the total nitrate-nitrogen accumulation, N_{T}, represents the total nitrate-nitrogen removed.

The time interval between measurements, I, may be so short, for example one second, that the total nitrate-nitrogen accumulation is essentially integrated to more accurately determine the amount of nitrate-nitrogen accumulation and make the process substantially continuous.

Then a comparison is made between the total nitrate-nitrogen accumulation, N_{T}, and the predetermined accumulated nitrate-nitrogen value, M, to determine when the total nitrate-nitrogen in the filter is equal to or greater than the predetermined accumulated nitrate-nitrogen value indicating that a bump should be performed. This comparison and determination of when to initiate a bump can be accomplished by any suitable method.

One method involves setting the total nitrate-nitrogen accumulation to zero immediately after a bump. After each time segment, the total nitrate-nitrogen accumulation, N_{T}, is compared to the predetermined accumulated nitrate-nitrogen value, M. When N_{T} becomes greater than or equal to the predetermined accumulated nitrate-nitrogen value, M, a bump is initiated. That is to say, when N_{T}≧M, a bump is initiated.

In a second method, the determined total nitrate-nitrogen accumulation is allowed to continuously increase and is not reset to zero. After each time segment, the total nitrate-nitrogen accumulation is compared to the total nitrate-nitrogen accumulation at the last bump, N_{TL}, plus the predetermined accumulated nitrate-nitrogen value, M. A bump is initiated when the total nitrate accumulation, N_{T} is greater than or equal to the total nitrate accumulation at the last bump, N_{TL}, plus the predetermined accumulated nitrate-nitrogen value, M. That is to say, when N_{T}≧N_{TL}+M, a bump is initiated.

In a third method, the determined total nitrate-nitrogen accumulation is allowed to continuously increase and is not reset to zero. After each time segment, a modified predetermined accumulated nitrate-nitrogen value, Mₘ, is determined by multiplying the predetermined accumulated nitrate-nitrogen value, M, by the number of bumps that have occurred prior to that segment, n, plus one. Thus, Mₘ=M*(n+1). The modified predetermined accumulated nitrate-nitrogen value, Mₘ, is compared to the total nitrate accumulation, N_{T}, and a bump is initiated when the total nitrate accumulation, N_{T}, is greater than or equal to the modified predetermined accumulated nitrate-nitrogen value, Mₘ. That is to say, when N_{T}≧Mₘ, or, put another way, N_{T}≧M*(n+1), a bump is initiated.

In a fourth method, the determined total nitrate-nitrogen accumulation is allowed to continuously increase and is not reset to zero. After each segment, the difference between the total nitrate accumulation at the time of the last bump, N_{TL}, and the total nitrate-nitrogen accumulation, N_{T}, at the end of the segment is determined. This difference is compared to the predetermined accumulated nitrate-nitrogen value, M, and a bump is initiated when the difference is greater than or equal to predetermined accumulated nitrate-nitrogen value. That is to say, when N_{T}−N_{TL}≧M, a bump is initiated.

As a further enhancement, the method may be modified to include a bump timing factor, B. The bump timing factor may be used to adjust the bump interval when the actual operating conditions are substantially different from the operating conditions that were present when the predetermined accumulated nitrate-nitrogen value was determined. The bump timing factor may be determined empirically or estimated based on experience and is based on factors such as: temperature, water quality, carbon source, media, etc.

Since different types of media may have different capabilities of holding nitrogen gas and different carbon sources have different bacterial yields which influence the maximal amount of nitrogen gas accumulation, the bump timing factor may be beneficial if different types of media arrangement and/or different carbon sources, such as acetic acid and ethanol, are used.

The bump timing factor may be inserted anywhere in the method as long as its magnitude and placement are chosen to adjust the bump timing factor in a manner appropriate for the operating conditions. For example, if the operating conditions indicate that the filter will accommodate more nitrate-nitrogen than the predetermined accumulated nitrate-nitrogen value without requiring a bump, then the bump timing factor should be inserted into the method such that it increases the time between bumps. Alternatively, if the operating conditions indicate that the filter will accommodate less nitrate-nitrogen removal than the predetermined accumulated nitrate-nitrogen value and will require a bump sooner, then the bump timing factor should be inserted into the equation such that it decreases the time between bumps.

For example, the total nitrate-nitrogen accumulation, N_{T}, may be divided by the bump timing factor, B, before it is compared with the maximum nitrate-nitrogen value. In this case, if the operating conditions indicate that the filter will accommodate more nitrate-nitrogen than the predetermined accumulated nitrate-nitrogen value without requiring a bump, the bump factor could be any number greater than one and may be between 1 and 10. If the operating conditions indicate that the filter will accommodate less nitrate-nitrogen removal than the predetermined accumulated nitrate-nitrogen value and will require a bump sooner, the bump factor should be less than one and may be between 0.1 and 1.

Alternatively, the predetermined accumulated nitrate-nitrogen value, M, could be multiplied by the bump timing factor, B, before it is compared with the total nitrate-nitrogen accumulation, N_{T}. In this case, if the operating conditions indicate that the filter will accommodate more nitrate-nitrogen than the predetermined accumulated nitrate-nitrogen value without requiring a bump, the bump factor could be any number greater than one and may be between 1 and 10. If the operating conditions indicate that the filter will accommodate less nitrate-nitrogen removal than the predetermined accumulated nitrate-nitrogen value and will require a bump sooner, the bump factor should be less than one and may be between 0.1 and 1.

This method is most effectively carried out by providing a processor having a memory, that is capable of communicating with, receiving input from and sending output to, and controlling the filter and any in-line measurement tools. The processor may be a PLC, a PC, or any other similar computer system capable of performing the described functions.

The total nitrate-nitrogen accumulation can be determined by the processor using any suitable method. One such method is described here. The effluent nitrate-nitrogen concentration set point and the flow rate set point may be either stored in the processor's memory or input to the processor by the operator. The processor outputs a signal to an in-line nitrate probe 1 located before the water enters the media bed 2 to take an influent nitrate concentration measurement, Nᵢ, and to an in-line nitrate probe 3 located after the water leaves the media bed 2 to take an effluent nitrate measurement, Nₑ. These measurements are taken at periodic set time intervals. The results of these measurements are input to the processor. The interval, I, for taking these measurements may be permanently stored in the processor's memory or input to the processor by the operator and stored in the memory until being changed. At the same time, the processor polls an in-line flow meter 4 to determine the flow rate, F, through the filter. The nitrate-nitrogen accumulation for the segment of the process that occurs between periodic measurements, Nₙ, is determined by the processor according to the following formula:

Nₙ=(Nᵢ−Nₑ)×F/A×I
Where:
Nₙ=nitrate-nitrogen accumulation for segment n, where n=the number of the segment after the bump
Nᵢ=measured nitrate concentration of the influent
Nₑ=measured nitrate concentration of the effluent
F=measure flow rate
A=area of the filter
I=time interval between measurements

Alternatively, the effluent nitrate concentration set point and/or the flow rate set point may be used in lieu of the measured values. In addition, the nitrate probes and flow meter may be set to take measurements at a periodic interval and input those values to the processor instead of the processor initiating the measurement. After each measurement, the processor adds the nitrate-nitrogen accumulation for that segment, Nₙ, to the sum of the nitrate-nitrogen accumulation for all segments since the last nitrogen release cycle or bump: N_{T}=ΣN₁, N₂, N₃ . . . .

The time interval between measurements, I, may be so short, for example one second, that the total nitrate-nitrogen accumulation is essentially integrated to more accurately determine the amount of nitrate-nitrogen accumulation and make the process substantially continuous.

Then the processor makes a comparison between the total nitrate-nitrogen accumulation, N_{T}, and the predetermined accumulated nitrate-nitrogen value, M, to determine when the total nitrate-nitrogen in the filter is equal to or greater than the predetermined accumulated nitrate-nitrogen value indicating that a bump should be performed. The predetermined accumulated nitrate-nitrogen value, M, may be either stored in the processor's memory or input by the operator. This comparison and determination of when to initiate a bump can be accomplished by the processor using any suitable method as previously described. When the processor has determined that a bump is necessary, it will output a signal to the filter to initiate the bump.

The method may further include a bump timing factor which is incorporated into the actions of the processor as described above.

The bump timing factor may be input to the processor by the operator. Alternatively, numerous bump timing factors may be stored in the processor's memory, and the processor can select a bump timing factor based on operating conditions. The operating conditions may be input to the processor manually or from in-line measuring devices such as nitrate probes, temperature sensors, flow meters, or the like. For example, the bump timing factor may be selected from the processor's memory based on temperature, water quality, carbon source, media type, etc. Here, temperature can be determined by a manual temperature input or temperature input from a temperature sensor communicating with the processor.

In addition, the bump interval for bumping the filter and the estimated timing remaining until the next bump may also be predicted. The time interval for bumping the filter may be predicted by determining total nitrate-nitrogen accumulation speed as a function of time based on at least the measured influent nitrate concentration and the measured effluent nitrate concentration and predicting a bump interval based on the total nitrate-nitrogen accumulation speed as a function of time and a predetermined accumulated nitrate-nitrogen value.

This may be accomplished by any suitable method. One such method is described here. An elapsed time, T, is determined. This may be done using a timer. The total nitrate-nitrogen accumulation, N_{T}, that has occurred during that elapsed time is determined as previously described either manually or using a processor. The total nitrate-nitrogen accumulation is divided by the product of the area of the filter, A, and the elapsed time, T, to determine total nitrate-nitrogen accumulation speed as a function of time, S(S=N_{T}/(T*A)). The bump interval is then determined by dividing the predetermined nitrate-nitrogen accumulation value, M, by the total nitrate-nitrogen accumulation speed as a function of time, S. Again, this may be accomplished manually or using a processor in a manner similar to that which was previously described for automating the bumping of the filter.

The amount of prior history used to determine total nitrate-nitrogen accumulation speed as a function of time, S, is determined by selecting a period of time after which the elapsed time and the total nitrate-nitrogen accumulation, N_{T}, are reset to zero. For example, only the history since the previous bump may be used by resetting immediately after every bump or the history of a number of bumps may used by not resetting until a number of bumps have occurred. Shorter reset periods may be more suited for operations with large variations in operating parameters, while longer reset periods may be more suitable for operations with fairly steady state operating conditions.

When using the previously described methods of determining total nitrate-nitrogen accumulation, the predicted bump interval may be determined after each time segment when the total nitrate-nitrogen accumulation is determined.

In addition, in a similar manner as previously described for automating the bumping of the filter, the predictions may be modified by a bump timing factor to account for operating changes that are known to be occurring during the predicted bump interval and/or were occurring when the prior history used for the determination was captured.

An estimated time until the next bump may be predicted by subtracting the elapsed time since the last bump from the bump interval.

It should be appreciated that the bump may also be initiated using the predicted bump interval.

It should also be realized that, in any of these methods, a full backwash to clean the media may be treated as a bump.

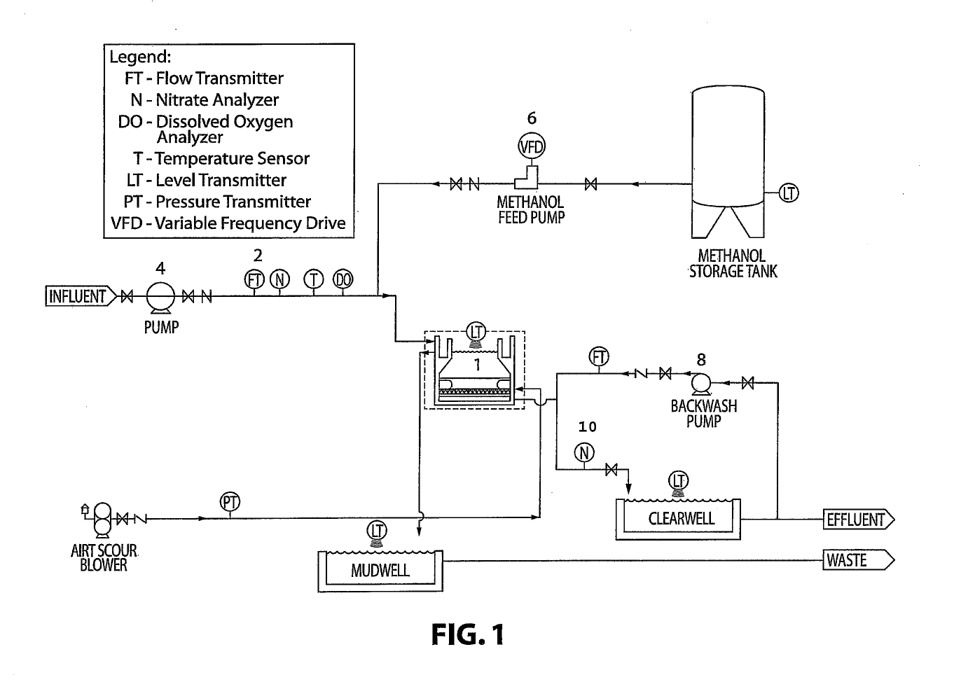

As the descriptions of the methods of using a processor described above indicates, a system may be provided for determining the optimum timing for bumping the filter. A typical system is shown in FIG. 1. Such a system would comprise a processor having a memory, an in-line nitrate probe located before the media bed 1 for measurement of the nitrate concentration of the influent (located in position 2 in FIG. 1), an in-line nitrate probe located after the media bed 1 for measurement of the nitrate concentration of the effluent (located position 10 in FIG. 1), an in-line flow meter for measurement of the flow rate of the water through the media bed (located in position 2 in FIG. 1), and a backwash system 8 for removing nitrogen from the media bed. The processor is capable of communicating with the in-line nitrate probes and the flow meter in position 2 and the backwash system 8 and initiating a bump to remove nitrogen from the media bed 1 based on the information provided by the in-line nitrate probes and the flow meter.

The invention claimed is:

1. A method for operation of a downflow denitrification filter having a media bed, an influent flow into the filter, and an effluent flow from the filter, comprising:
measuring the influent nitrate concentration using off-line measurements or in-line measurement tools;
measuring the effluent nitrate concentration using off-line measurements or in-line measurement tools;
determining total nitrate-nitrogen accumulation based on at least the measured influent nitrate concentration and the measured effluent nitrate concentration; and
initiating a bump of the filter based on a comparison of the total nitrate-nitrogen accumulation with a predetermined accumulated nitrate-nitrogen value.

2. The method according to claim 1, wherein the predetermined accumulated nitrate-nitrogen value is 0.05 lbs/sq. ft. of filter area per bump.

3. The method according to claim 1, further comprising using an adjustable bump timing factor to account for differences in operating conditions from those used to determine the predetermined accumulated nitrate-nitrogen value.

4. The method according to claim 3, wherein the bump timing factor is based on temperature, water quality, rainfall events, operational changes, operator observations, or a combination thereof.

5. The method according to claim 1, wherein the total nitrate-nitrogen accumulation is determined by a method comprising:
periodically determining the concentration of nitrate in the influent and the effluent at regular time intervals;
using the influent and effluent nitrate concentrations, a flow rate through the filter, an area of the filter, and the time interval between determination of consecutive nitrate concentration measurements to determine the accumulation of nitrate-nitrogen for a segment of the process occurring between two measurements; and
summing consecutively the nitrate-nitrogen accumulation from each segment of the process to determine the total nitrate-nitrogen accumulation.

6. The method according to claim 1, wherein the comparison of the total nitrate-nitrogen accumulation to the predetermined nitrate-nitrogen accumulation value is accomplished by one of the following methods:
setting the total nitrate-nitrogen accumulation to zero after each bump and, after each segment, comparing the predetermined accumulated nitrate-nitrogen value to the total nitrate-nitrogen accumulation and initiating a bump when the total nitrate-nitrogen accumulation is greater than or equal to predetermined accumulated nitrate-nitrogen value;
after each segment, comparing the total nitrate-nitrogen accumulation to the total nitrate-nitrogen accumulation at the last bump plus the predetermined accumulated nitrate-nitrogen value and initiating a bump when the total nitrate-nitrogen accumulation is greater than or equal to the total nitrate-nitrogen accumulation at the last bump plus the predetermined accumulated nitrate-nitrogen value;
after each segment, comparing a modified predetermined accumulated nitrate-nitrogen value determined by multiplying the predetermined accumulated nitrate-nitrogen value by a number of bumps that have occurred prior to that segment plus one to the total nitrate-nitrogen accumulation and initiating a bump when the total nitrate-nitrogen accumulation is greater than or equal to the modified predetermined accumulated nitrate-nitrogen value; or
after each segment, comparing the difference between the total nitrate-nitrogen accumulation at the time of the last bump and the current total nitrate-nitrogen accumulation to the predetermined accumulated nitrate-nitrogen value and initiating a bump when the difference is greater than or equal to predetermined accumulated nitrate-nitrogen value.

7. The method according to claim 5, wherein the effluent nitrate concentration, the flow rate, or both are a set point.

8. The method according to claim 5, wherein the time interval is set to be short making the measurement steps substantially continuous.

9. The method according to claim 1, further comprising providing a processor, having a memory, that is capable of communicating with, receiving input from, sending output to and controlling the filter and any in-line measurement tools, the processor performing at least one of the method steps.

10. The method according to claim 9, further comprising using an adjustable bump timing factor to account for differences in operating conditions from those used to determine the predetermined accumulated nitrate-nitrogen value, wherein a plurality of bump timing factors are stored in the processor's memory and the processor selects a bump timing factor based on an operating condition input either manually by the operator or from the in-line measuring tools with which it communicates.

11. The method according to claim 9, wherein a time interval for taking nitrate concentration measurements is either stored in the memory of the processor or input by the operator such that the processor initiates the measurement by communicating with the nitrate probes and the flow meter.

12. A method for operating a downflow denitrification filter having a media bed, an influent flow to the filter, and an effluent flow from the filter comprising:
determining total nitrate-nitrogen accumulation speed as a function of time based on at least the measured influent nitrate concentration and the measured effluent nitrate concentration as determined by off-line measurements or in-line measurement tools; and
predicting a bump interval for when to bump the filter based on the total nitrate-nitrogen accumulation speed as a function of time and a predetermined accumulated nitrate-nitrogen value.

13. The method according to claim 12, wherein the predetermined accumulated nitrate-nitrogen value is 0.05 lbs/sq. ft. of filter area per bump.

14. The method according to claim 12, further comprising using an adjustable bump timing factor to account for differences in operating conditions from those used to determine the predetermined accumulated nitrate-nitrogen value.

15. The method according to claim 14, wherein the bump timing factor is based on temperature, water quality, rainfall events, operational changes, or a combination thereof.

16. The method according to claim 12, further comprising determining the estimated time remaining until the next bump by subtracting an elapsed time since the last bump from the bump interval.

17. The method according to claim 12, further comprising initiating a bump based on the predicted bump interval.

18. The method according to claim 12, wherein the total nitrate-nitrogen accumulation speed as a function of time is determined by a method comprising:
determining elapsed time;
periodically determining the concentration of nitrate in the influent and the effluent at regular time intervals;
using the influent and effluent nitrate concentrations, a flow rate through the filter, an area of the filter, and the time interval between determination of consecutive nitrate concentration measurements to determine the accumulation of nitrate-nitrogen for a segment of the process occurring between two measurements;
summing consecutively the nitrate-nitrogen accumulation from each segment of the process to determine the total nitrate-nitrogen accumulation; and
dividing the total nitrate-nitrogen accumulation by the product of the area of the filter and the elapsed time.

19. The method according to claim 18, wherein the elapsed time is reset to zero after a period of time which based on a length of prior history selected for determining the total nitrate-nitrogen accumulation speed as a function of time.

20. The method according to claim 19, wherein the elapsed time is reset to zero immediately after a bump or after a selected number of bumps.

21. The method according to claim 18, wherein the prediction of the bump interval is made, after each segment, by dividing the predetermined nitrate-nitrogen accumulation value by the total nitrate-nitrogen accumulation speed as a function of time.

22. The method according to claim 18, wherein the effluent nitrate concentration, the flow rate, or both are a set point.

23. The method according to claim 18, wherein the time interval is set to be short making the measurement steps substantially continuous.

24. The method according to claim 12, further comprising providing a processor, having a memory, that is capable of communicating with, receiving input from and sending output to, and controlling the filter and any in-line measurement tools, the processor performing at least one of the method steps.

25. The method according to claim 24, further comprising using an adjustable bump timing factor to account for differences in operating conditions from those used to determine the predetermined accumulated nitrate-nitrogen value, wherein a plurality of bump timing factors are stored in the processor's memory and the processor selects a bump timing factor based on an operating condition input either manually by the operator or from the in-line measuring tools with which it communicates.

26. The method according to claim 24, wherein a time interval for taking nitrate concentration measurements is either stored in the memory of the processor or input by the operator such that the processor initiates the measurement by communicating with in-line measurement tools.
